(19) United States
(12) Patent Application Publication
(10) Pub. No.: US 2022/0123560 A1
(43) Pub. Date: Apr. 21, 2022

(54) Scalable Power System for Vehicles

(71) Applicant: LOON LLC, Mountain View, CA (US)

(72) Inventors: Kevin Anderson, Sunnyvale, CA (US); Jim Morash, Melrose, CA (US)

(73) Assignee: LOON LLC, Mountain View, CA (US)

(21) Appl. No.: 17/072,699

(22) Filed: Oct. 16, 2020

(51) Int. Cl. H02J 7/00; H01M 10/615; H01M 10/42; H01M 10/46; H01M 10/63; B60L 50/60; B60L 58/18; B60L 58/27; B60L 58/12; B60L 53/00

(52) U.S. Cl. CPC H02J 7/0013; H02J 7/0029; H02J 7/0048; H01M 10/615; H01M 10/425; H01M 10/46; H01M 2220/20; B60L 50/66; B60L 58/18; B60L 58/27; B60L 58/12; B60L 53/00; H01M 2010/4271; H01M 10/63

(57) ABSTRACT

The technology relates to a scalable power system. A scalable power system includes battery modules connected in parallel, a network of diodes, a battery management system that may be localized or centralized, a localized battery management system configured to control an individual battery module, a centralized battery management system configured to control all of the battery modules in the scalable power system. In a system with localized battery control, a parallelizing circuit board may connect battery modules to a system bus in parallel. The battery modules can be charged and discharged by the system bus. A method of adding a battery module to a scalable power system includes discharging a highest-charged battery module, then discharging a next highest-charged battery module until there are no remaining charged battery modules, then adding an additional battery module in parallel, and charging the connected battery modules in parallel.

### BACKGROUND OF INVENTION

Individual vehicles or sub-fleets in a vehicle fleet may be purposed for different missions with different power requirements. It can be inefficient to equip all vehicles in the fleet with sufficient power to run all types of missions, particularly for vehicles where mass is a limiting factor (i.e., lighter than air or wind-driven vehicles). Further, certifying a different power system for different missions can be time consuming.

Thus, a solution for a scalable power system for vehicles is desired.

### BRIEF SUMMARY

The present disclosure provides techniques for a scalable power system for vehicles. A scalable power system may include: two or more battery modules connected in parallel; a network of diodes; two or more battery management systems, each of the two or more battery management systems configured to control a respective battery module of the two or more battery modules; a parallelizing circuit board configured to connect the two or more battery modules to a system bus in parallel; and a system bus configured to charge and discharge the two or more battery modules, wherein the parallelizing circuit board is further configured to combine the power inputs from the two or more battery modules into the system bus. In some examples, the parallelizing circuit board is further configured to combine the power inputs from the two or more battery modules into the system bus. In some examples, the parallelizing circuit board comprises a discrete heater control configured to regulate voltage to a heating element for each of the two or more battery modules. In some examples, the parallelizing circuit board comprises a power and signal connector for each of the two or more battery modules. In some examples, each power and signal connector is configured to couple a heater control to a corresponding one of the two or more battery modules. In some examples, each power and signal connector is configured to couple a master power and signal connector to a corresponding one of the two or more battery modules. In some examples, the system further comprises a power in connection and a power out connection between each of the two or more battery modules and its corresponding power and signal connector. In some examples, a plurality of power and signal connectors are connected to a master power and signal connector in parallel, each of the plurality of power and signal connector corresponding to one of the two or more battery modules. In some examples, the parallelizing circuit board comprises a master power and signal connector coupled to the system bus. In some examples, each of the two or more battery management systems is configured to provide one, or a combination, of the following local control and safety functions: conducting power in and out of a corresponding one of the two or more battery modules, monitor and enforce safety for the corresponding one of the two or more battery modules, reporting telemetry, serving as a pass through for power to a heating element.

An alternative scalable power system may include: two or more battery modules; a network of diodes; a central battery management system configured to control the two or more battery modules and to join the two or more battery modules in parallel; and a system bus configured to charge and discharge the two or more battery modules, wherein the central battery management system is further configured to combine the power inputs from the two or more battery modules into the system bus. In some examples, the central battery management system is configured to provide one, or a combination, of the following control and safety functions across the two or more battery modules: conducting power in and out of the two or more battery modules, monitor and enforce safety for the two or more battery modules, reporting telemetry, serving as a pass through for power to a heating element. In some examples, each of the two or more battery modules comprises a first side connector and a second side connector, the first side connector on one of the two or more battery modules configured to couple with the second side connector on another of the two or more battery modules. In some examples, the first side connector and the second side connector are configured to connect the two or more battery modules physically. In some examples, the first side connector and the second side connector are configured to connect the two or more battery modules electrically.

A method of adding a battery module to a scalable power system may include: discharging, by a system bus, a highest-charged battery module in the scalable power system, the battery system comprising one or more previously added battery modules; determining whether there are any remaining charged battery modules in the scalable power system; based on a determination that there are remaining charged battery modules in the scalable power system, discharging a next highest-charged battery module; based on a determination that there are no remaining charged battery modules, adding an additional battery module to the scalable power system in parallel with the one or more previously added battery modules, the additional battery module and the one or more previously added battery modules forming a scaled up power system; and charging in parallel, by the system bus, a plurality of battery modules in the scaled up power system, the plurality of battery modules comprising the previously added battery modules and the additional battery module. In some examples, the plurality of battery modules are connected in parallel to the system bus using a battery management system. In some examples, the plurality of battery modules are connected in parallel to the system bus using a parallelizing circuit board. In some examples, the parallelizing circuit board comprises a discrete heater control configured to regulate voltage to a heating element for each of the two or more battery modules. In some examples, each of the plurality of battery modules is controlled by a local battery management system.

### BRIEF DESCRIPTION OF THE DRAWINGS

Various non-limiting and non-exhaustive aspects and features of the present disclosure are described hereinbelow with references to the drawings, wherein:

FIG. 1A is a simplified block diagram of an exemplary scalable power system for vehicles, in accordance with one or more embodiments.

FIG. 1B is a simplified block diagram showing relevant components of a parallelizing board, in accordance with one or more embodiments.

FIG. 2 is a simplified block diagram of another exemplary scalable power system for vehicles.

FIGS. 3A-3D are schematic diagrams of exemplary vehicle systems in which a scalable power system for vehicles may be implemented, in accordance with one or more embodiments.

FIG. 4 is a flow diagram illustrating an exemplary method for adding a battery module to a scalable power system, in accordance with one or more embodiments.

FIG. 5 is a simplified block diagram of an exemplary computing system in communication with scalable power systems in FIGS. 1A and 2, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The term “vehicle” is used herein to refer to any type of moveable mode of transporting people, goods, or any other payload, which may use electric power (e.g., derived from solar or other renewable energy source) to run one or more components. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive lighter than air vehicles (e.g., floating stratospheric balloons, other floating or wind-driven vehicles), powered lighter than air vehicles (e.g., balloons and airships with some propulsion capabilities), fixed-wing vehicles (e.g., drones, rigid kites, gliders), various types of satellites, and other high altitude aerial vehicles.

The invention is directed to a scalable power system comprised of modular battery units (i.e., battery modules), particularly for use in vehicles with different power requirements due to differing vehicle characteristics and/or differing missions (e.g., with different duration, weather or other environmental conditions, requisite equipment for service). This allows for ease of scalability (i.e., increase and decrease) of power provisioned for a vehicle, with the addition or removal of modular batteries.

Two or more battery modules may be connected in parallel using a circuit with a network of diodes, designed to safely place the batteries in parallel even if they are at different states of charge when they are connected (the diodes configured to prevent each battery module from charging another battery module to which it is connected). The two or more battery modules each may be comprised of a plurality of battery cells, each battery module configured to provide a given maximum amount of power. The two or more battery modules may each be controlled by one or more battery monitoring units or battery management systems (BMS) (e.g., a PCBA or other circuit board). “BMS” is used herein to refer to either or both of a battery monitoring unit and battery management system. In an example, each battery module may be controlled locally by its own BMS, each BMS electrically coupled to a parallelizing circuit board configured to join the two or more battery modules in parallel and combine the power inputs from the two or more battery modules into as few as one system bus (i.e., a power bus). The two or more battery modules may be charged and discharged by the system bus. The parallelizing circuit board also may be configured to control a heating unit to regulate the temperature of the batteries. In another example, the two or more battery modules may be controlled by a central or master BMS, each of the two or more battery modules configured to be connected to another battery module, the battery modules connected in parallel to the central BMS.

The process for electrically adding (after physically connecting) a battery module to an existing power system (i.e., another battery module or an existing group of two or more already joined battery modules), to increase a system battery capacity, begins with discharging the highest-charged battery module(s) first. To the extent more than one battery module is already joined by the system bus, the system bus discharges one or more battery modules at each successive battery voltage level until all of the already joined batteries have been discharged to a common open circuit voltage, at which point the diode may allow an additional battery module to join the system bus. In some examples, a plurality of additional battery modules may be joined to the system bus. The two or more battery modules that are then joined to the system bus may be charged in parallel. Once charged, the two or more batteries may remain active on the bus for the duration of their lifetime, or of a current mission.

Example Systems

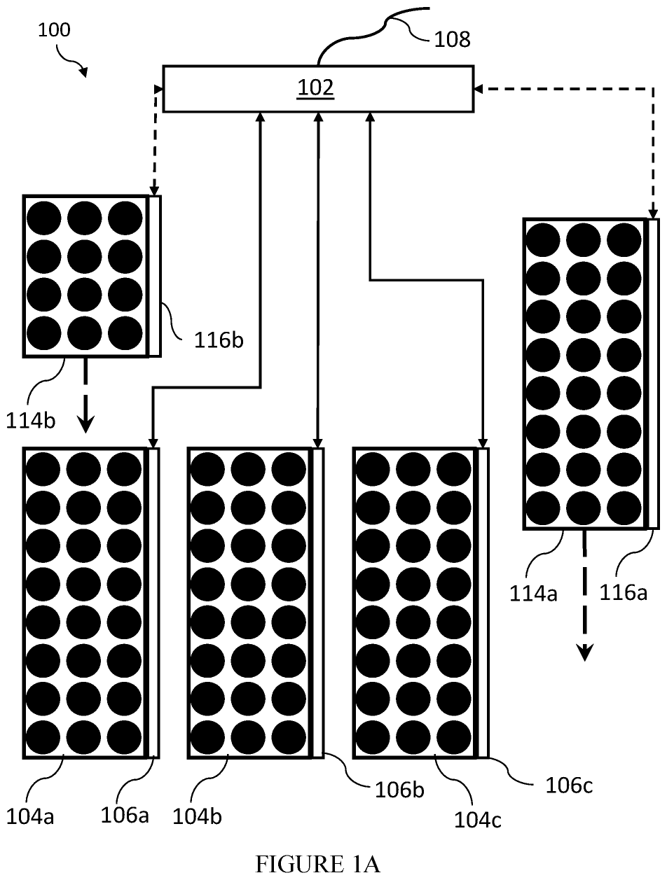

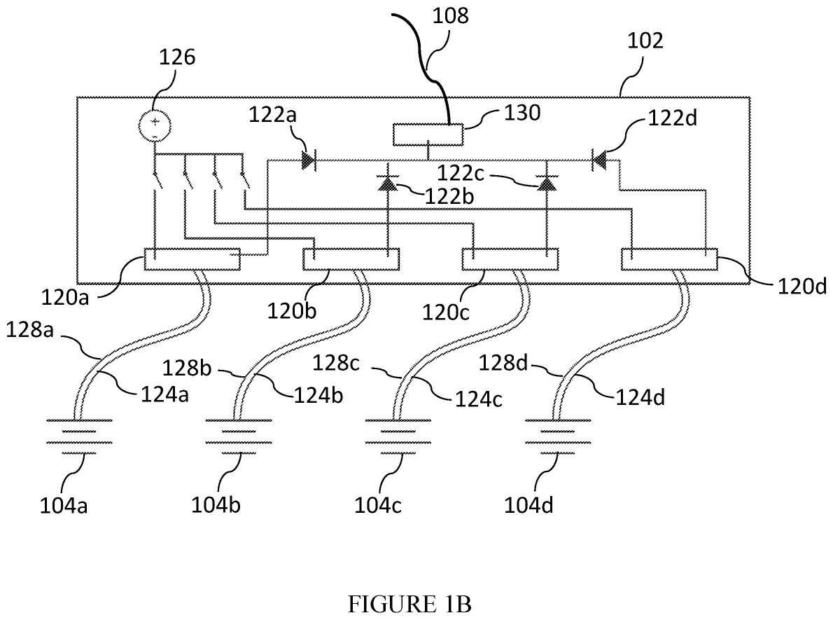

FIG. 1A is a simplified block diagram of an exemplary scalable power system for vehicles, in accordance with one or more embodiments. In some examples, scalable power system 100 may implement a modular battery design that allows a vehicle or flight operator to scale the actual amount of energy storage that is provided in a vehicle to suit the vehicle mission. In some examples, a vehicle mission may be a flight, ride or sailing to travel to and/or from a location to another location (i.e., a trip). In some examples, the vehicle mission may include another objective (e.g., to carry a payload (e.g., passenger, cargo, equipment) and/or provide a service (e.g., take sensor readings, provide data connectivity, capture images) during, or at a designated point (e.g., a destination, one or more intermediary locations) on, the trip). In other examples, the vehicle mission may be simply to take the trip, without any other objective. For example, a flight being performed by an aerial vehicle may fly a given flight path, which may be expected to encounter higher or lower levels of solar energy (i.e., impacting the energy that can be collected) than another flight that may fly a different flight path. A flight carrying a given payload to carry out a given mission (e.g., a communications payload for providing data connectivity, a sensor suite for taking sensor readings, image capture devices) also might require a given threshold amount of energy storage that is greater than or less than another flight in order to power the vehicle (i.e., to ensure it can carry the mass of the vehicle and equipment for the given flight path) and to power the equipment (i.e., to carry out an objective of the mission). Similarly, a truck or other ground vehicle may make a trip carrying more or less cargo or passenger weight than another trip, and have to power more or less equipment during the trip than during another trip (e.g., a van carrying and powering energy-intensive weather sensing equipment versus an empty van making a return trip after dropping off cargo). Making efficient use of energy storage on a vehicle enables the vehicle to take advantage of the mass and volume savings of not carrying more battery capacity than necessary in impactful ways (e.g., enabling longer flights, enabling a vehicle to travel more quickly to a destination, enabling a vehicle to carry a larger and/or heavier payload).

System 100 may include parallelizing board (i.e., parallelizing circuit board) 102, battery packs (i.e., battery modules) 104a-c, added battery modules 114a-b, and system bus 108. Battery modules 104a-c and added battery modules 114a-b may comprise any type of battery known in the art (e.g., Lithium ion, lead-acid, lithium polymer). Battery modules 104a-c and added battery modules 114a-b each may be an independent battery unit controlled by an individual BMS 106a-c and 116a-b, respectively. Each of BMS 106a-c and 116a-b may be configured to provide local control and safety functions for each battery, including one, or a combination, of: conducting power in and out of a corresponding battery module, monitoring and enforcing safety for the corresponding battery module, reporting telemetry, serving as a pass through for power to a heating element. In some examples, conduction of power in and out of a battery module may be controlled by a power field-effect transistor (FET). In some examples, an analog front end (AFE) integrated circuit may be used to monitor and enforce safety (e.g., measure battery cell voltage, measure battery and/or BMS temperature, and balance circuitry). Telemetry that may be reported can include open-circuit voltage, other voltage measurements, temperature, and more. In some examples, power to the heating element may be regulated and controlled by parallelizing board 102, as shown in FIG. 1B (e.g., heater control 126 regulating power to battery modules 104a-c and 114a).

Each of battery modules 104a-c may be connected in parallel (e.g., to prevent each battery pack from charging another battery pack) using parallelizing board 102. In some examples, one or both of added battery modules 114a-b may be added to battery system 100 by connecting each in parallel to parallelizing board 102. In some examples, a battery module 114a having the same size and capacity as battery modules 104a-c may be added to battery system 100. In other examples, battery module 114b having a different size and capacity than battery modules 104a-c may be added to battery system 100. The broken-line down arrows indicate placement examples of added battery modules 114a-b. Similar to battery modules 104a-c, each of which is controlled by one of BMS 106a-c, respectively, added battery modules 114a-b each is controlled one of BMS 116a-b, respectively. In some examples, as shown, battery modules 104a-c and 114a-b may be connected to parallelizing board 102 through BMS 106a-c and 116a-b, respectively.

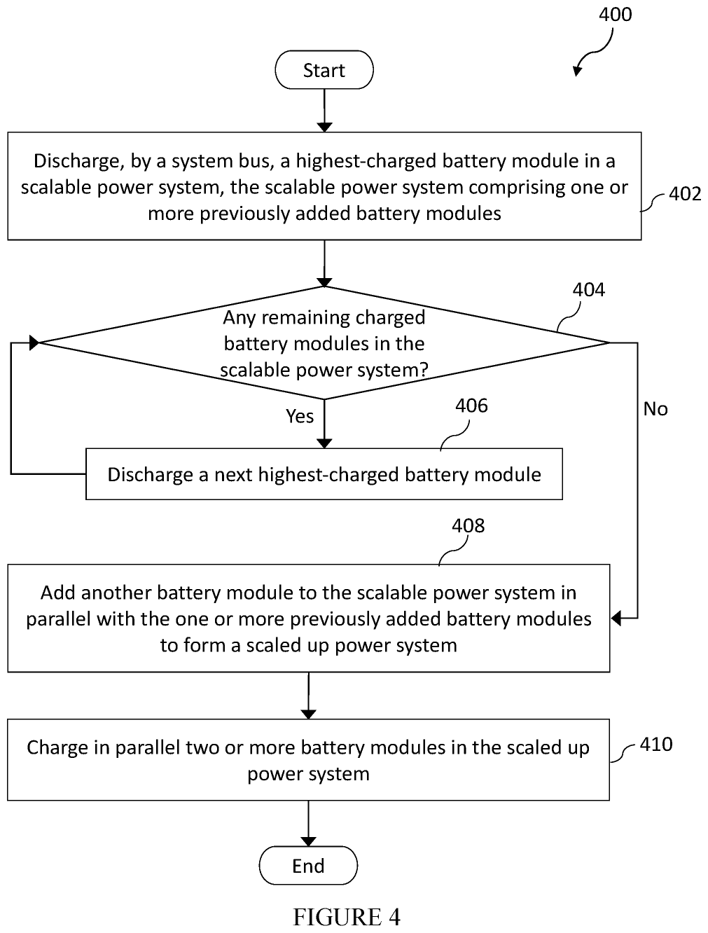

In some examples, battery modules 104a-c may be charged by solar panels (not shown) via the system bus. A discharge-charge cycle of battery modules 104a-c and/or adding and charging battery modules 116a-b may be performed according to the method in FIG. 4 (e.g., method 400).

FIG. 1B is a simplified block diagram showing relevant components of a parallelizing board, as may be implemented in scalable power system 100 in FIG. 1A, in accordance with one or more embodiments. All like-numbered elements in FIG. 1B are the same or similar to their corresponding elements in FIG. 1A, as described above. Parallelizing board 102 may include power and signal connectors 120a-d, diodes 122a-d, heater control 126, and master power and signal connector 130. Master power and signal connector 130 may serve as the master power and control connection between parallelizing board 102 and system bus 108. Power and signal connectors 120a-d may connect one or both of heater control 126 and master power and signal connector 130 with battery modules 104a-d through power out connections 124a-d and power in connections 128a-d, respectively. Power and signal connectors 120a-d may be connected in parallel to master power and signal connector 130 using diodes 122a-d. Power in connections 128a-d may be configured to provide power to battery modules 104a-c and 114a, for example, to charge its respective battery module and/or power a heating element. Power out connections 124a-d may be configured to draw power from battery modules 104a-d, for example, to discharge its respective battery module.

Heater control 126 may be separate from system bus 108. In some examples, power for heating battery modules 104a-d may be provided through system bus 108, but may be regulated to a different voltage (e.g., including being turned on or off) by heater control 126, as shown. In some examples, heater control 126 regulates power to a heating element (not shown) by an individual FET. In some examples, power for heating may be provided by one or more of battery modules 104a-d, which may provide power out to system bus 108 (e.g., by one or more of power out connections 124a-d), which may then send power back to one or more of battery modules 104a-d, as needed to power a heating element. In other examples, heater control 126 may control an independent source of power for heating battery modules 104a-d (not shown).

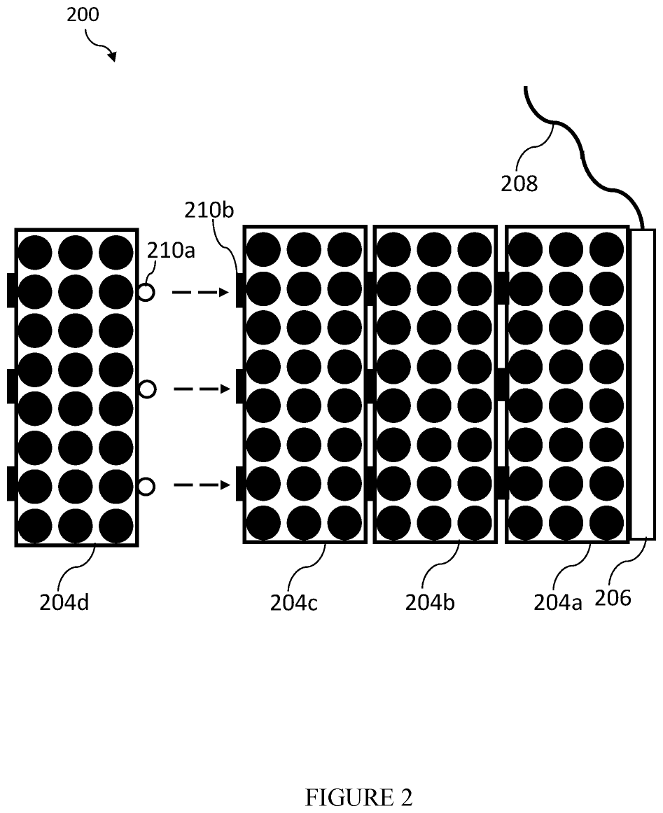

FIG. 2 is a simplified block diagram of another exemplary scalable power system for vehicles. Scalable power system 200 may include battery modules 204a-c, added battery module 204d, BMS 206, and system bus 208. BMS 206 may function the same or similarly to BMS 106a-c and 116a-b in FIG. 1A, as described above. Battery modules 204a-c and added battery module 204d may function the same or similarly to battery modules 104a-c and added battery modules 114a-b in FIG. 1A-1B, as described above. However, rather than being locally controlled by individual BMS's and connecting in parallel to a parallelizing board, battery modules 204a-c and added battery module 204d may be connected in parallel to a central BMS 206. Added battery module 204d may be added to system 200 through a coupling system comprising a first side connector 210a and a second side connector 210b, the first side connector 210a (i.e., on a side of battery module 204d, or a side of any one of battery modules 204a-c) of configured to fit with the second side connector 210b (i.e., on another side of battery module 204c, or another side of any one of battery modules 204a-d). In some examples, the first side connector 210a and second side connector 210b may comprise a plug and socket, plug and jack, jack and socket, male and female connector, or other physical and/or electrical connector pair. Although there are three (3) connector pairs shown on each of battery modules 204a-d, one of ordinary skill in the art will recognize that more or fewer connector pairs may be used to physically and electrically connect one of battery modules 204a-d to another of battery modules 204a-d. BMS 206 may be configured to provide control and safety functions for all of battery modules 204a-c and added battery module 204d. This configuration with a central BMS 206 may reduce mass (i.e., relative to an amount of battery capacity) in system 200, as compared to system 100, in exchange for reduced redundancy and visibility into local performance by each battery module.

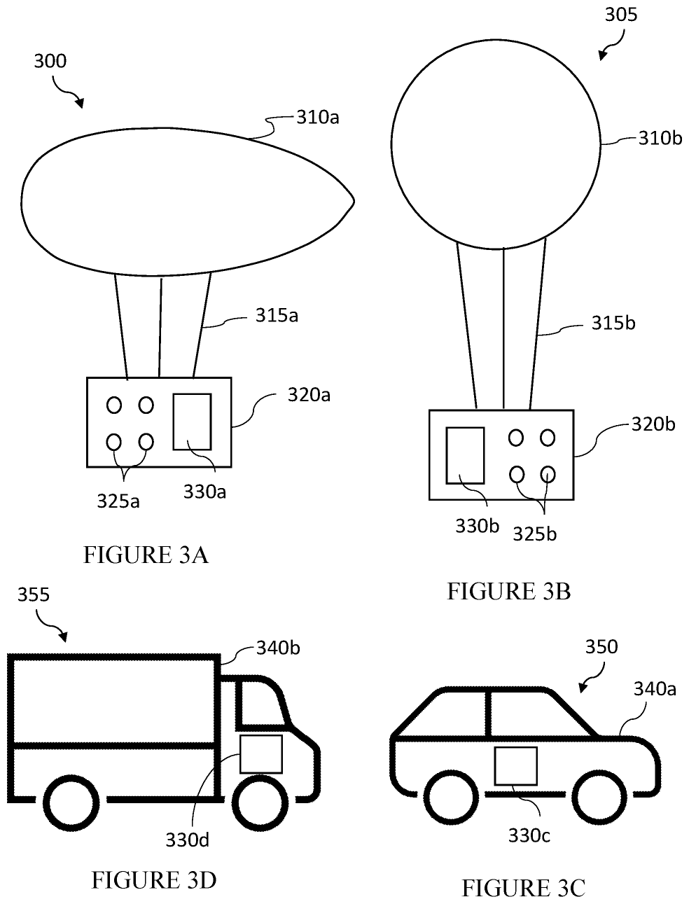

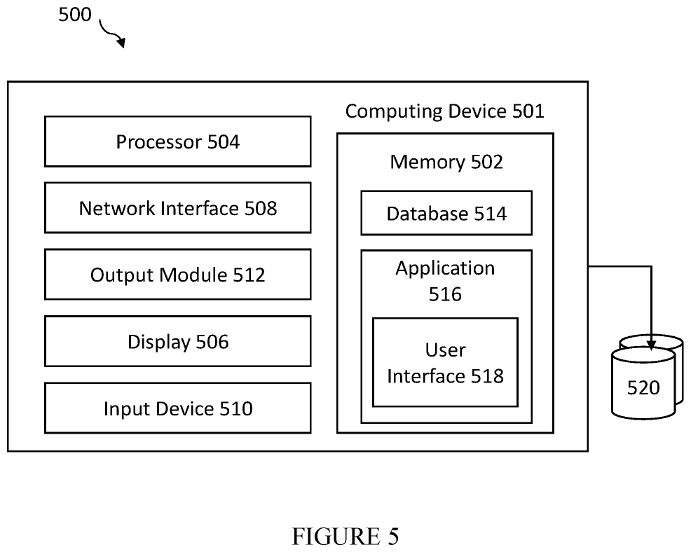

FIGS. 3A-3D are schematic diagrams of exemplary vehicle systems in which a scalable power system for vehicles may be implemented, in accordance with one or more embodiments. Aerial vehicle systems 300 and 305 in FIGS. 3A-3B may include balloons (e.g., superpressure, dirigible) 310a-b carrying payloads 320a-b, which may comprise various sensors 325a-b and battery units 330a-b. Battery units 330a-b may comprise scalable power systems comprising one or more battery modules, as described herein. Aerial vehicle systems 300 and 305 may be in communication with a computing device (e.g., computing device 501 in FIG. 5, using communications units, not shown, onboard the aerial vehicles) to send telemetry, receive commands, and exchange other data. In some examples, the aerial vehicles may be wind-influenced or wind-driven aerial vehicles. In other examples, the aerial vehicles may be partially or wholly actively propelled. In some examples, the aerial vehicles may float and/or fly to, within, and among, one or more regions, layers, or sub-layers of the atmosphere (e.g., troposphere, lower stratosphere, stratosphere, mesosphere, etc.), and may be configured to withstand extreme winds, temperatures, and air composition, among other environmental factors.

Sensors 325a-b may include Global Positioning System (GPS) sensors, wind speed and direction sensors such as wind vanes and anemometers, temperature sensors (e.g., thermometers, thermistors, thermocouples, and resistance temperature detectors (RTDs)), speed of sound sensors, acoustic sensors, pressure sensors such as barometers and differential pressure sensors, accelerometers, gyroscopes, combination sensor devices such as inertial measurement units (IMUs), light detectors, pyranometers, light detection and ranging (LIDAR) units, radar units, cameras, other image sensors (e.g., a star tracker), and more. These examples of sensors are not intended to be limiting, and those skilled in the art will appreciate that other sensors or combinations of sensors in addition to these described may be included without departing from the scope of the present disclosure.

Payload 320a-b may comprise a controller, or other computing device or logic circuit configured to control components of aerial vehicle systems 300 and 305. In an embodiment, payload 320a-b may be coupled to balloons 310a-b, respectively, using one or more down-connects 315a-b configured to couple payload 320a-b and balloons 310a-b physically, electrically and/or communicatively (i.e., capable of one- and/or two-way power and data transfer). Payload 320a-b may include, or be coupled to, sensors 325a-b, respectively.

In some examples, balloons 310a-b may carry and/or include other components that are not shown (e.g., altitude control system, propeller, fin, electrical and other wired connections, avionics chassis, onboard flight computer, ballonet, communications systems including transceivers, gimbals, and parabolic terminals). Those skilled in the art will recognize that the systems and methods disclosed herein may similarly apply and be usable by various other types of aerial vehicles.

Ground vehicle systems 350 and 355 in FIGS. 3C-3D may include ground vehicles 340a-b and battery units 330c-d. Battery units 330c-d may comprise scalable power systems comprising one or more battery modules, as described herein. Battery units 330c-d may power operations of ground vehicles 340a-b, including a motor, an engine, a plurality of sensors or other equipment, not shown.

FIG. 4 is a flow diagram illustrating an exemplary method for adding a battery module to a scalable power system, in accordance with one or more embodiments. Method 400 may begin with discharging, by a system bus, a highest-charged battery module in a scalable power system at step 402, the scalable power system comprising one or more previously added battery modules. At step 404, a determination may be made whether there are any remaining charged battery modules in the scalable power system. If yes, a next highest-charged battery module at step 406. Then method 400 returns to step 404 to determine again whether there are any remaining battery modules in the scalable power system. If no, then another battery module may be added to the scalable power system in parallel with the one or more previously added battery modules, at step 408, to form a scaled up power system. In some examples, step 408 may comprise adding two or more battery modules, depending on the power capacity desired for the power system for a vehicle to carry out a mission. In some examples, step 408 may include physically connecting the other (i.e., additional) battery module to a parallelizing board, and then allowing the other battery module to electrically connect to the bus. In other examples, the other battery module may already be physically connected to the parallelizing board, which is configured to keep the other battery module electrically separate from the one or more previously added battery modules until step 408 when it is safe for the other battery module to be electrically connected to the bus. In some examples, two or more battery modules in the scaled up power system may be charged in parallel, at step 410, the two or more battery modules comprising the previously added battery modules and the other battery module added in step 408. In some examples, a battery module also may be removed by discharging according to steps 402-406 of this method, and then electrically and physically disconnecting the battery module from the parallelizing board. The battery module also may be physically removed from the scalable power system and the vehicle in which it is installed.

FIG. 5 is a simplified block diagram of an exemplary computing system in communication with scalable power systems in FIGS. 1A and 2, in accordance with one or more embodiments. Computing system 500 may be configured to receive and store telemetry from a scalable power system (e.g., scalable power systems 100 and 200 in FIGS. 1A and 2, respectively), and to provide commands (e.g., battery power commands, heater control commands, BMS and other control commands). In some examples, computing system 500 may be configured to perform computations, run power simulations and/or algorithms to generate power commands, navigate vehicles, generate trip plans (e.g., for a flight, a sail journey, a ground trip, and the like), dispatch vehicles, generate and assign missions (i.e., comprising objectives), and perform other functions. In some examples, computing system 500 may comprise a server computer. In some examples, computing system 500 may comprise or be part of a distributed computing system.

In one embodiment, computing system 500 may include computing device 501 and storage system 520. Storage system 520 may comprise a plurality of repositories and/or other forms of data storage, and it also may be in communication with computing device 501. In another embodiment, storage system 520, which may comprise a plurality of repositories and may be housed in one or more of computing device 501 (not shown). In some examples, storage system 520 may store state data, other telemetry, commands (e.g., flight, navigation, communications, mission, fallback), flight policies, and other various types of information as described herein. Such information may be retrieved or otherwise accessed by one or more computing devices, such as computing device 501, in order to perform some or all of the features described herein. Storage system 520 may comprise any type of computer storage, such as a hard-drive, memory card, ROM, RAM, DVD, CD-ROM, write-capable, and read-only memories. In addition, storage system 520 may include a distributed storage system where data is stored on a plurality of different storage devices, which may be physically located at the same or different geographic locations (e.g., in a distributed computing system). Storage system 520 may be networked to computing device 501 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 501 also may include a memory 502. Memory 502 may comprise a storage system configured to store a database 514 and an application 516. Application 516 may include instructions which, when executed by a processor 504, cause computing device 501 to perform various steps and/or functions, as described herein. Application 516 further includes instructions for generating a user interface 518 (e.g., graphical user interface (GUI)). Database 514 may store various algorithms and/or data, including neural networks (e.g., encoding flight policies, navigation policies, power simulators) and data regarding power usage, power telemetry, power requirements, battery characteristics, weather forecasts, past and present locations of vehicles (e.g., aerial vehicle systems 300 and 305 in FIGS. 3A-3B, ground vehicle systems 350 and 355 in FIGS. 3C-3D), sensor data, map information, air traffic information, ground traffic information, water conditions, among other types of data. Memory 502 may include any non-transitory computer-readable storage medium for storing data and/or software that is executable by processor 504, and/or any other medium which may be used to store information that may be accessed by processor 504 to control the operation of computing device 501.

Computing device 501 may further include a display 506, a network interface 508, an input device 510, and/or an output module 512. Display 506 may be any display device by means of which computing device 501 may output and/or display data. Network interface 508 may be configured to connect to a network using any of the wired and wireless short range communication protocols described above, as well as a cellular data network, a satellite network (e.g., Iridium, Inmarsat), free space optical network and/or the Internet. Input device 510 may be a mouse, keyboard, touch screen, voice interface, and/or any or other hand-held controller or device or interface by means of which a user may interact with computing device 501. Output module 512 may be a bus, port, and/or other interface by means of which computing device 501 may connect to and/or output data to other devices and/or peripherals.

In some examples computing device 501 may be located remote from a vehicle (e.g., aerial vehicle systems 300 and 305 in FIGS. 3A-3B, ground vehicle systems 350 and 355 in FIGS. 3C-3D) and may communicate with and/or control the operations of a vehicle via a network. In one embodiment, computing device 501 is a data center or other control facility (e.g., configured to run a distributed computing system as described herein), and may communicate with a controller and/or flight computer via a network. As described herein, system 500, and particularly computing device 501, may be used for planning a trip for a vehicle (e.g., along a desired heading, within a desired radius of a target location, to one or more destinations one-way or round trip). Various configurations of system 500 are envisioned, and various steps and/or functions of the processes described below may be shared among the various devices of system 500, or may be assigned to specific devices.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

1. A scalable power system comprising:
two or more battery modules connected in parallel;
a network of diodes;
two or more battery management systems, each of the two or more battery management systems configured to control a respective battery module of the two or more battery modules;
a parallelizing circuit board configured to connect the two or more battery modules to a system bus in parallel; and
a system bus configured to charge and discharge the two or more battery modules,
wherein the parallelizing circuit board is further configured to combine the power inputs from the two or more battery modules into the system bus.

2. The power system of claim 1, wherein the parallelizing circuit board is further configured to:
connect the two or more battery modules with an additional battery module in parallel, and
combine the power inputs from the two or more battery modules and the additional battery module into the system bus after the additional battery module is physically connected to the parallelizing circuit board.

3. The power system of claim 1, wherein the parallelizing circuit board comprises a discrete heater control configured to regulate voltage to a heating element for each of the two or more battery modules.

4. The power system of claim 1, wherein the parallelizing circuit board comprises a power and signal connector for each of the two or more battery modules.

5. The power system of claim 4, wherein each power and signal connector is configured to couple a heater control to a corresponding one of the two or more battery modules.

6. The power system of claim 4, wherein each power and signal connector is configured to couple a master power and signal connector to a corresponding one of the two or more battery modules.

7. The power system of claim 4, further comprising a power in connection and a power out connection between each of the two or more battery modules and its corresponding power and signal connector.

8. The power system of claim 1, wherein a plurality of power and signal connectors are connected to a master power and signal connector in parallel, each of the plurality of power and signal connector corresponding to one of the two or more battery modules.

9. The power system of claim 1, wherein the parallelizing circuit board comprises a master power and signal connector coupled to the system bus.

10. The power system of claim 1, wherein each of the two or more battery management systems is configured to provide one, or a combination, of the following local control and safety functions: conducting power in and out of a corresponding one of the two or more battery modules, monitor and enforce safety for the corresponding one of the two or more battery modules, reporting telemetry, serving as a pass through for power to a heating element.

11. A scalable power system comprising:
two or more battery modules;
a network of diodes;
a central battery management system configured to control the two or more battery modules and to join the two or more battery modules in parallel; and
a system bus configured to charge and discharge the two or more battery modules,
wherein the central battery management system is further configured to combine the power inputs from the two or more battery modules into the system bus.

12. The power system of claim 11, wherein the central battery management system is configured to provide one, or a combination, of the following control and safety functions across the two or more battery modules: conducting power in and out of the two or more battery modules, monitor and enforce safety for the two or more battery modules, reporting telemetry, serving as a pass through for power to a heating element.

13. The power system of claim 11, wherein each of the two or more battery modules comprises a first side connector and a second side connector, the first side connector on one of the two or more battery modules configured to couple with the second side connector on another of the two or more battery modules.

14. The power system of claim 13, wherein the first side connector and the second side connector are configured to connect the two or more battery modules physically.

15. The power system of claim 13, wherein the first side connector and the second side connector are configured to connect the two or more battery modules electrically.

16. A method of adding a battery module to a scalable power system, the method comprising:
discharging, by a system bus, a highest-charged battery module in the scalable power system, the battery system comprising one or more previously added battery modules;
determining whether there are any remaining charged battery modules in the scalable power system;
based on a determination that there are remaining charged battery modules in the scalable power system, discharging a next highest-charged battery module;
based on a determination that there are no remaining charged battery modules, adding an additional battery module to the scalable power system in parallel with the one or more previously added battery modules, the additional battery module and the one or more previously added battery modules forming a scaled up power system; and
charging in parallel, by the system bus, a plurality of battery modules in the scaled up power system, the plurality of battery modules comprising the previously added battery modules and the additional battery module.

17. The method of claim 16, wherein the plurality of battery modules are connected in parallel to the system bus using a battery management system.

18. The method of claim 16, wherein the plurality of battery modules are connected in parallel to the system bus using a parallelizing circuit board.

19. The method of claim 18, wherein the parallelizing circuit board comprises a discrete heater control configured to regulate voltage to a heating element for each of the two or more battery modules.

20. The method of claim 18, wherein each of the plurality of battery modules is controlled by a local battery management system.
